(19) United States
(12) Patent Application Publication
(10) Pub. No.: US 2024/0059502 A1
(43) Pub. Date: Feb. 22, 2024

(54) FLEXIBLE HIGH SPEED MANUFACTURING CELL (HSMC) SYSTEM

(71) Applicant: AKRIBIS SYSTEMS PTE LTD, Singapore (SG)

(72) Inventors: Yong Peng LEOW, Singapore (SG); Kenneth PHEY, Singapore (SG); Rayner TAN, Singapore (SG); Yi Yang TENG, Singapore (SG)

(21) Appl. No.: 18/269,899

(22) PCT Filed: Feb. 3, 2021
(86) PCT No.: PCT/SG2021/050053

§ 371 Date: Jun. 27, 2023

(51) Int. Cl. B65G 47/86; B65G 47/90

(52) U.S. Cl. CPC B65G 47/847; B65G 47/90

(57) ABSTRACT

A high speech manufacturing cell (HSMC) (80) system is disclosed. The system comprises a plurality of high speech manufacturing cells (80) linked together to allow parts on a production line to flow through each cell (80) and be processed. Each of the HSMCs performs a multitude of manufacturing processes via the use of direct drive linear and/or rotary motors. The invention includes a smart alignment methodology (SAM) together with an interfacing for HSMCs or the likes in reducing the overall time taken to set up manufacturing lines on site.

### TECHNICAL FIELD

This invention relates to flexible high-speed manufacturing cell (HSMC) system used in automated manufacturing, and in particular, each of HSMC is able to perform a myriad of manufacturing processes on parts and facilitate the parts to be transferred from one point to another within the HSMC. The system is applicable to the fabrication of electrical and electronic modules or assembly or subassemblies.

### BACKGROUND ART

The predominate approach today to introduce factory automated technology into manufacturing is to selectively apply automation and to create islands of automation, which is meant an approach allows the transition from convention or mechanical manufacturing to the automated assembly.

In today's rapidly changing environment, where products' lifecycle is reduced, businesses are looking to ramp up production or to setup new production lines within a short time frame to meet consumer demands and achieve market competitiveness. A conventional method of having high throughput would be the addition of parallel lines or processing multiple products simultaneously. The drawbacks of these methods are the increase in floor space, the increase requirement for looser product tolerances and the increase risk of jams or crashes within the processing station. A survey conducted by the NSF Engineering Research Center for Reconfigurable Manufacturing Systems at the University of Michigan revealed that industries are “Very Dissatisfied” with large floor space that multi-stage systems occupy (as referenced in US 2004/0255449 A1). This concern is still very much relevant as factories consider maximizing the use of manufacturing space. Concerns on issues pertaining to product handling during production are also relevant as the increasing compactness and complexity in today's manufactured products requires varied intricate processes to manufacture.

Manufacturing lines can also be relocated for the following economic or logistical reasons; a country's attractiveness for the industry, access to raw material, reduction in logistical cost, to be geographically nearer to the targeted marker sector, or making space for a secondary manufacturing line within the production floor. With each shift, time is needed to set it up at the new location; this reduces the overall operational efficiency of the manufacturing line.

US Patent Publication No. 2004/0255449A1 discloses a combined chassis and floor system for use in off-site factory built structures comprising: a pair of parallel interior longitudinal beam members having an upper surface defining a common plane, a pair of end perimeter members joined to ends of the interior longitudinal beam members, the end perimeter members extending laterally beyond the interior longitudinal beam members, and extending above the common plane, a pair of longitudinal perimeter members joined to ends of the end perimeter members to form with the end perimeter members a rectangular perimeter assembly, ledger members fixed to an inner surface of the longitudinal perimeter members, the ledger members having an upper surface lying in said common plane, and a plurality of metal floor joists extending laterally between the longitudinal perimeter members having a lower surface lying in said common plane and an upper surface lying in a plane defined by upper surfaces of the perimeter members.

U.S. Pat. No. 8,584,349, entitled “Flexible Manufacturing System” discloses a manufacturing system comprising (a) a core that is adapted to supply utilities for multiple manufacturing processes and preferably is capable of high capacity supply, (b) and at least two, three, four, five, six, seven, eight, nine, ten or more movable manufacturing bays adapted to be removably coupled to the core and adapted for receiving the utilities supplied from the core. In some embodiments, within the workspace defined by each bay, there is a facility for performing one or more manufacturing processes, or portions or steps of manufacturing processes, which can optionally be performed in parallel. The facility may comprise a plurality of components, each of which performs one or more portions or steps of a chemical, a biological, a pharmaceutical, or some other manufacturing process. The manufacturing system optionally includes a plurality of clean connect areas positioned adjacent to the manufacturing bays when connected to the core for controlling access to the manufacturing bays and/or providing a clean area for making the utility connections between the core and the manufacturing bays. The manufacturing system further optionally includes a plurality of upper docking collars positioned above the bays when connected to the core for supplying one or more utilities to the bays (e.g., under the force of gravity). The manufacturing system optionally comprises one, two, or more holding areas where a movable bay can be cleaned, and where optionally the configuration of components that perform the manufacturing process, or portions or steps of manufacturing processes, can be reconfigured. The manufacturing system optionally comprises a drain, adapted to be removably connected to the one or more movable manufacturing bays, for discharging waste generated during a manufacturing process. The drain for discharging waste is preferably isolated from the core, so as to avoid contamination of the core.

U.S. Pat. No. 8,798,787, entitled “Ultra-Flexible Production Manufacturing” discloses manufacturing system has one or more work cells that each performs one or more manufacturing processes. The system also has one or more mobile transport units (“MTUs”) that deliver transportable containers containing workpieces to and from said work cells. The MTUs deliver the containers to the work cells in a manner such that the workpieces are localized in the work cells. The manufacturing system also has a computer system that has status information for each of the one or more MTUs and uses the status information to control each of the one or more MTUs to deliver the transportable containers to and from the one or more work cells.

### SUMMARY OF THE INVENTION

The high-speed manufacturing cell (HSMC) of the present invention uses a combination of direct drive motors (rotary and/or Linear) to achieve high speed and precise motion, and smart alignment methodologies to cover aspects of manufacturing products; from part handling to alignment of manufacturing line.

A main object of the present invention is to provide a high-speed manufacturing cell (HSMC) system for performing a myriad of manufacturing processes on an input part or more parts, the system comprising:
one or more primary rotary tables (100, 100′) which is circular and is rotated by a direct drive rotary motor (14) located underneath the rotary plates (10, 10′), wherein the rotary motor (14) together with the rotary plates (10, 10′) are positioned on a mounting spacer (16), and the circumferential edge of the primary rotary plates (10, 10′) are mounted with a plurality of nests (12) for holding the part; and
a plurality of secondary rotary turrets (20, 20′) adjacently positioned along the circumferential edge of the primary rotary table (100), wherein the secondary rotary turret (20) comprises a direct drive rotary motor (24); a plurality of end effectors (22, 22′) each being provided with a pair of mechanical jaws (23) to pick and place the part onto the nest (12) on the primary rotary plate (10);
thereby the part is transferred from one place to another place to be processed and/or to form a sub-assembly in the course of pick and place by the end effector (22) of the secondary rotary turret (20).

Still another main object of the present invention is to provide a high-speed manufacturing cell (HSMC) system for performing a myriad of manufacturing processes on an input part or more parts, the system comprising:
one or more primary rotary tables (100, 100′) which is circular and is rotated by a direct drive rotary motor (14) located underneath the plates (10, 10′), wherein the rotary motor (14) together with the rotary plates (10, 10′) are positioned on a mounting spacer (16), and the circumferential edge of the primary rotary plates (10, 10′) are mounted with a plurality of nests (12) for holding the part; and
a plurality of secondary rotary turrets (20, 20′) adjacently positioned along the circumferential edge of the primary rotary table (100), wherein the secondary rotary turret (20) comprises a direct drive rotary motor (24); a plurality of end effectors (22, 22′) each being provided with a pair of mechanical jaws (23) to pick and place the part onto the nest (12) on the primary rotary plate (10); and
at least one station (30) positioned above the circumferential edge of the primary rotary plate (10) to provide a manufacturing process to the part on the nest (12), thereby
the part is transferred from one place to another place to be processed and/or to form a sub-assembly in the course of pick and place by the end effectors (22) of the secondary rotary turret (20).

A further main object of the present invention is to provide a high-speed manufacturing cell (HSMC) employing a smart alignment methodology for performing a myriad of manufacturing processes on input part/parts comprising one or more HSMCs with a mounting spacer (16), a secondary rotary turret (20) equipped with a programmable linear actuator (28) to allow parts to be assembled in vertical direction to form sub-assemblies of parts, wherein a teach point is set to the programmable linear actuator (28) based on the height of the part to be picked.

Yet still another object of the present invention is to provide a high-speed manufacturing cell (HSMC) employing a smart alignment methodology, further comprising a linear track system to facilitate a plurality of HSMCs to be in alignment in a manufacturing line, wherein the linear track system comprises a fixed stand to allow the part to be placed onto and or picked from the linear track system; and a linear track assembly containing machined parts with orifices to allow a fluid medium to pass through, providing a lift and propulsion the part when the assembly interacts with the part. The linear track system is used to bridge two or more HSMC (80) units in the manufacturing line.

An object of the present invention is to provide a flexible high speed manufacturing cell (HSMC) system which employs direct drive motor to produce for high speed throughput and precision movement of each individual part, completing each manufacturing process within a very short time.

Yet another object of the present invention to provide a flexible high speed manufacturing cell system, wherein by handling individual parts, adjustments can be made to cater for slight part variations. This allows parts with tighter tolerances to be handled repeatably without issues such as jamming, crashing or falling off. Unlike traditional non-direct drive means of automation (i.e. belt drive, gears, cam followers), direct drive motors require little to no maintenance. With zero downtime required from maintenance of motors, overall operational efficiency and throughput of the HSMC is higher.

Still another object of the present invention is to provide a flexible high speed manufacturing cell system, wherein each individual high speed manufacturing cells (HSMCs) can be configured with each other in orthogonal and/or acute/obtuse manners to form a manufacturing line.

A further object of the present invention is to provide a flexible high speed manufacturing cell system which has the ability to be arranged and interact with each other in a flexible manner allowing for manufacturing lines to be designed according to the floor space available on site.

Still a further object of the present invention is to provide a flexible high speed manufacturing cell system, wherein dense manufacturing lines with the ability to complete a variety of Manufacturing Processes in a quick and precise manner would allow businesses alleviate operational costs, whilst maintain high throughput.

Still another main object of the present invention to provide a flexible high speed manufacturing cell system, wherein smart alignment methodologies associated with the Invention of HSMCs involve the use of linear programmable actuators is used to allow individual parts to be handled along the Z axis. Stack up tolerances inherent in assemblies can be eliminated with the HSMC's ability to set teach points in the Z axis.

Yet still a further object of the present invention is to provide a flexible high speed manufacturing cell system, wherein the need for highly skilled workers to mechanically align all aspects of the manufacturing line is thus reduced, decreasing overall costs and time taken to set up the manufacturing line in various locations.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic perspective view of a high-speed manufacturing cell (HSMC) in accordance with the system of the present invention, wherein two stations, three secondary rotary turrets and one primary rotary table are shown;

FIG. 2A is a perspective view of a primary rotary table of the HSMC in accordance with the present invention, wherein the circular rotary table is located on top of the rotary motor mounted on the mounting spacer;

FIG. 2B is the top view of the primary rotary table of the HSMC of the present invention;

FIG. 3A is a perspective view of a mechanical jaw end effector of a secondary rotary turret in accordance with the present invention;

FIG. 3B is a perspective view of a vacuum suction end effector of a secondary rotary turret in accordance with the present invention;

FIG. 4 is schematic top view showing the flow of parts in a HSMC in accordance with the present invention, wherein the system includes three secondary rotary turrets and the primary rotary table together with two stations in accordance with the present invention;

FIG. 5 is a top view showing schematically the converging of 2 inputs to 1 output of parts in a HSMC in accordance with the present invention;

FIG. 6 is a top view showing schematically the diverging 1 input to 2 outputs of parts in a HSMC in accordance with the present invention;

FIG. 7 is a top view showing iteration 1 of manufacturing line in accordance with the present invention, wherein three HSMCs are employed;

FIG. 8 is a top view showing iteration 2 of manufacturing line in accordance with the present invention, wherein four HSMCs are employed;

FIG. 9 is a perspective view illustrating the primary rotary table of the HSMC in accordance with the present invention, wherein a plurality of nests are mounted along the circumferential edge of the primary rotary table;

FIG. 10 is a perspective view illustrating the secondary rotary turret of the HSMC in accordance with the present invention;

FIG. 11 is section view showing the types of nests mounted at the edge of the primary rotary table in accordance with the present invention;

FIG. 11A is section view of a locating nest in accordance with the present invention;

FIG. 11B is section view of a translating nest in accordance with the present invention;

FIG. 11C is section view of a rotating nest in accordance with the present invention;

FIG. 11D is section view of a clamping nest in accordance with the present invention;

FIG. 12A is a schematic illustration showing 4UP secondary rotary turret that is associated with the high speed manufacturing cell in accordance with the present invention;

FIG. 12B is a schematic illustration showing 6UP secondary rotary turret that is associated with the high speed manufacturing cell in accordance with the present invention;

FIG. 13 is a schematic illustration depicting an iteration of the high speed manufacturing cell (HSMC) that is created with the rearrangement of primary rotary tables, secondary rotary turrets, and/or stations in accordance with the present invention;

FIG. 14 is a schematic illustration showing an iteration of manufacturing line, made by combining 2 different HSMCs in accordance with the present invention;

FIG. 15 is a schematic illustration showcasing primary rotary tables of different Height to facilitate handling of parts of different geometric dimensions, as well as stacking of 2 different parts together to form a sub assembly in accordance with the present invention;

FIG. 16 is a schematic illustration depicting another iteration of the high speed manufacturing cell (HSMC) that allows for the inclusion of redundancies in automation in accordance with the present invention;

FIG. 17 is a schematic illustration showing the picking up of a part via smart alignment of HSMC in accordance with the present invention;

FIG. 18 is a schematic illustration showing alignment between adjacent HSMC units in a Manufacturing Line in accordance with the present invention.

### BEST MODE FOR CARRYING OUT THE INVENTION

Hereinafter, embodiments according to the present invention will be described in detail with reference to the accompanying drawings such that those skilled in the art to which the present invention belongs can realize the present invention without difficulty. The present invention may, however, be embodied in different forms and should not be construed as limited to the embodiments set forth herein. In the drawings, anything unnecessary for describing the present invention will be omitted for clarity. Like reference numerals denote like elements throughout.

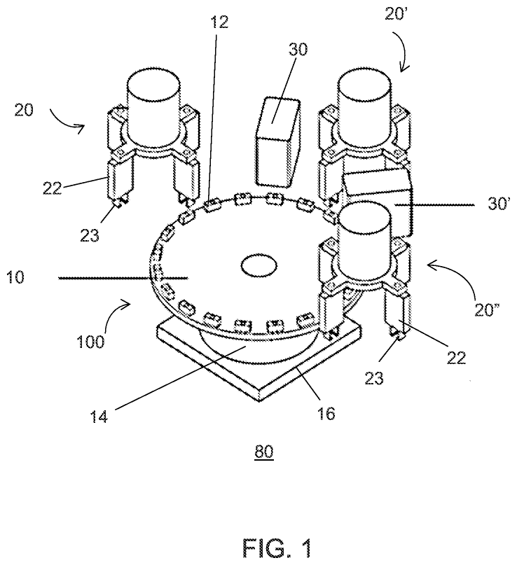

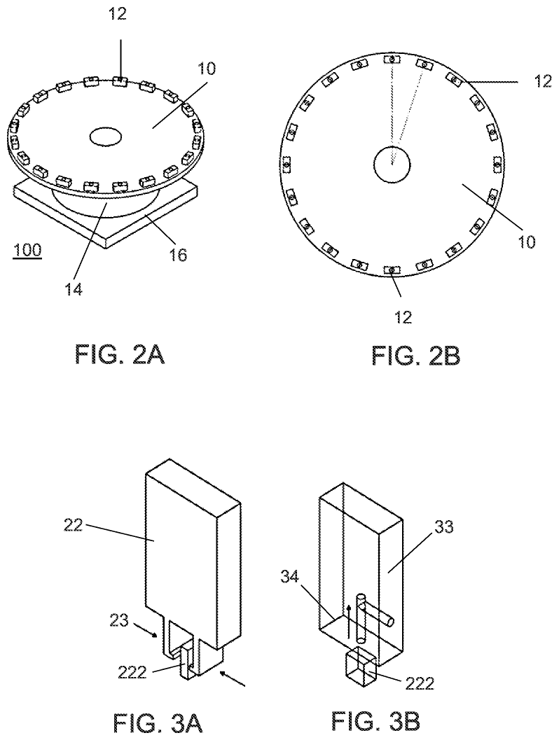

FIG. 1 is a schematic perspective view of a high speed manufacturing cell (HSMC) (80) in accordance with the system of the present invention. FIGS. 2A and 2B are illustrations of the primary rotary table (100) of the high speed manufacturing cell (80) in accordance with the present invention.

Referring to FIGS. 1, and 2A and 2B, the HSMC (80) by system of flexible high speed manufacturing cell (80) comprises: a primary rotary table (100); a plurality of secondary rotary turrets (20, 20′, 20″); and at least one station (30, 30′). The primary rotary table (100) is circular and is driven to rotate by a direct drive rotary motor (14) mounted onto a mounting spacer (16). The direct drive rotary motor (14) is positioned beneath the lower surface of the primary rotary plate (10) but is located on the upper surface of the mounting spacer (16). A plurality of nests (12) are disposed along the circumferential edge of the primary rotary plate (10) and these nests (12) are meant for holding a part (not shown), used in manufacturing processes, in each of the nests (12), allowing the manufacturing processes to be acted on it.

As shown in FIG. 2A, the primary rotary plate (10) includes the plurality of nests (12), the direct drive rotary motor (14) and the mounting spacer (16) as mentioned earlier. The rotary plate (10) is driven by the rotary motor (14), which indexes the nests (12) mounted on the rotary plate (10) by an angle in a quick and precise manner. This allows the part to be transferred from one point to another.

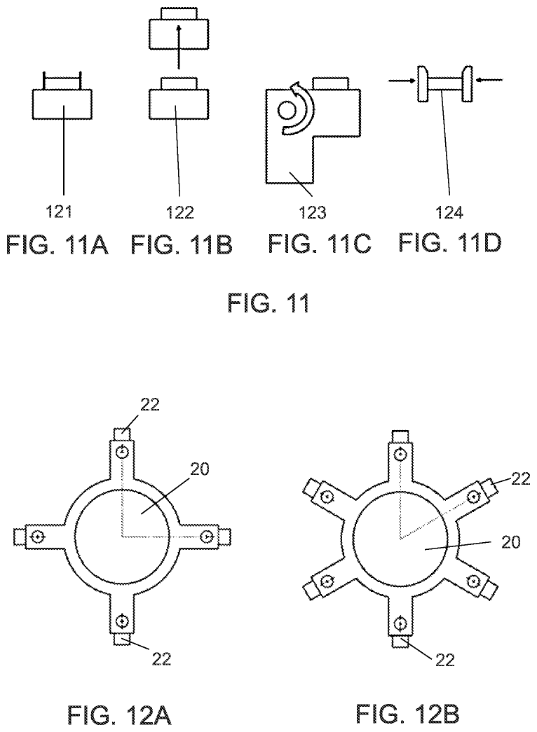

The nests (12) that are mounted along the circumferential edge of the primary rotary plate (10) can take up a variety of forms, each depending on individual functionality and/or functionalities to facilitate the part that handling in the manufacturing processes. In a preferred embodiment, the nests (12) can take up to but not limited to those shown in FIG. 11. FIG. 11 schematically shows the types of nests (12) associated with the primary rotary plate (10), including a locating nest (121), a translating nest (122), a rotating nest (123), and a clamping nest (124). FIG. 11A is section view of a locating nest in accordance with the present invention; FIG. 11B is section view of a translating nest in accordance with the present invention; FIG. 11C is section view of a rotating nest in accordance with the present invention; and FIG. 11D is section view of a clamping nest in accordance with the present invention.

Referring to FIG. 11, in the preferred embodiment, the locating nest (121) provides a reference surface for the part to be handled to sit upon. The complaint mechanism and/or device may be integrated with this nest to provide a passive force to keep the part held in place in the course of transferring by the primary rotary table (100). The locating nest (121) may undergo surface treatment of varying degrees to be compatible with Vision Systems for Measurement of Part critical dimensions.

The translating nest (122) allows the part to be translated in the linear direction. The part may be transferred between the primary rotary tables (100, 100′, 100″ . . . ) across different vertical and/or horizontal planes. The compliant mechanisms and/or devices may be integrated with this translating nest (122) to provide a passive force to keep the part held in place during the transfer by the primary rotary table (100). The translating nest (122) may undergo heat treatment process to increase the hardness factor thereof for interaction with the part to be handled.

The rotational nest (123) allows the part to be rotated about the axis thereof. The axis to be rotated may be any axes in a classical Cartesian Coordinate System. The part may be rotated by but not limited to the following angles: 45 degrees, 90 degrees, 180 degrees, and 270 degrees. The compliant mechanisms and/or devices maybe integrated with this rotational nest (123) to provide a passive and/or active means of keeping the part in place during the transfer by the primary rotary table (100). The rotational nest (123) may involve the crafting of a metal piece with orifices that facilitates the flow of fluid through the orifices, to provide an active and/or passive force to act upon the part to be handled.

The clamping nest (124) allows the part to momentarily change its geometric dimensions. The complaint mechanisms and/or devices may be integrated with this clamping nest (124) to provide a passive/and or active means of keeping the part momentarily deformed during the transfer by the primary rotary table. This clamping nest (124) may be acted upon by an external and/or internal force to revert the part back to its original geometric dimensions.

In accordance with the preferred embodiment of the present invention, other such iterations of nests may be a result of the amalgamation of the above mentioned functionalities, i.e. nests that translate parts across different planes whilst compressing them. The variety of nests that is associated with the primary rotary table allows parts of different geometrical shapes, material, size to be handled. The HSMC (80) of the present invention would thus be sufficiently flexible to perform various manufacturing processes on varied input parts. The wide range of nests that can be mounted on the primary rotary plate (10) allows the HSMC (80) to be flexible in handling different part input formats as well, such as, Stamping Reel, Tape and Reel, Vibratory Bowl.

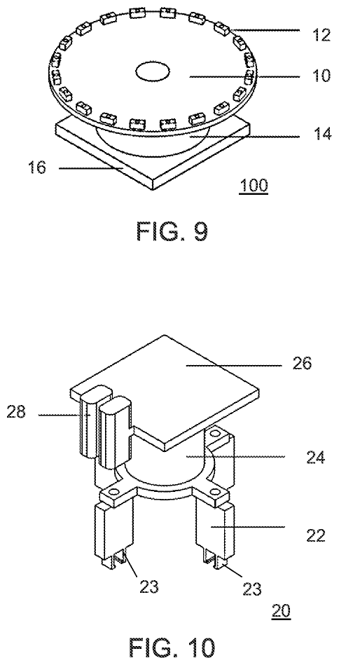

The use of the direct drive rotary motor (14) for the primary rotary table (100) allows the iterations of nests (121, 122, 123, 124) to be positioned precisely and rapidly. This is shown in FIG. 9 of the present invention. FIG. 9 is a perspective view illustrating the primary rotary table (100) of the HSMC (80) in accordance with the present invention, wherein a plurality of nests (12) are mounted along the circumferential edge of the primary rotary plate (10). A plurality of duplicate nests (12) are installed onto the primary rotary plate (10), and the rotary motor (14) indexes each nests (12) at an angle theta, where theta=360 degrees/N (where N is the number of nests installed). For a high-speed manufacturing, indexing of angle theta can be completed within a short time frame. To achieve even greater speeds, the mass of the nests can be reduced via design optimization, and/or the use of alternative lightweight materials. The number of nests (12) to be installed on the primary rotary plate (10) is dependent on the diameter of the primary rotary plate (10); the larger the diameter of the primary rotary plate (10), the greater the number of duplicate nests (12) to be installed on the primary rotary plate (10) to achieve a lower theta angle. For example: For N>=16, where the diameter of the primary rotary table (10) is 470 mm, the indexing of each nest (12) can be completed in 0.06 s, enabling high speed transfer of parts from one point to another. The primary rotary plate (10) mainly serves as a platform upon which manufacturing processes are carried out. In order to allow the HSMC (80) of the present invention to maintain a high throughput, the cycle time of manufacturing processes is able to be reduced by the use of direct drive rotary motors (14).

The ability to create unique primary rotary table (100) that handles distinct parts with minimal changes to the basic elements of a primary rotary table (100), makes the HSMC (80) flexible and be adaptable to engineering changes. For example, should there be a change in design of geometric shape of part to be handled, only the nests (12) would need to be changed; the rotary table (100), the direct drive rotary motor (14), the mounting spacer (16) can be maintained the same without any alteration, and the types of nests are shown in FIG. 11. Accordingly the cost of engineering changes for different geometric shape of part would be reduced drastically, increasing rate of investment returns.

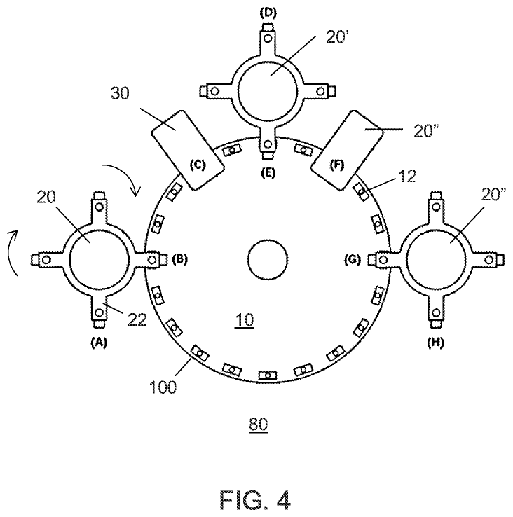

FIG. 10 is a perspective view illustrating a secondary rotary turret (20) of the HSMC (80) in accordance with the present invention. The secondary rotary turret (20) comprises a mounting plate (26), a direct rotary motor (24), a plurality of end effectors (22, 22′) with a pair mechanical jaws (23) (as shown in FIG. 3A) or with a suction means, which is shown by an arrow (34), indicating the direction of suction, and at least one programmable linear actuators (28). FIG. 3A is a perspective view of a mechanical jaw (23) end effector (22) of a secondary rotary turret (20) in accordance with the present invention and FIG. 3B is a perspective view of a vacuum suction end effector (22) of the secondary rotary turret (20) in accordance with the present invention. The end effectors (22, 22′) interact with the part, facilitating part transfer in a rotary manner as shown in FIG. 4. The mechanic jaws (23) are located at one end of the end effector (22) for use to pick and place of part onto or from the rotary table (100) of HSMC (80) of the present invention, as shown in FIG. 3A.

In the preferred embodiment of the present invention, the end effectors (22, 22′) may involve the use of mechanical jaws (23) to hold on to the part during transfer by means of clamping and/or gripping. To facilitate the handling of different parts of varying geometrical dimensions, the mechanical jaws (23) or an end effectors tip can be changed quickly with relative ease. A type of end effectors tip can be developed to allow clamping/gripping of the parts with flat surfaces. In other preferred embodiment, another type of tip for gripping of the parts can be developed that allows the parts with concave features to be tightly clamped. Another type of tips for gripping of parts can be developed to allow the Parts with recessed features to be gripped.

In accordance with the present invention, the end effectors (22, 22′) may also involve the use of suction to hold on to the part during transfer via a fluid medium. The end effectors tip can also be changed easily to allow part handling of different geometries. In some cases, a type of picker tips can be developed to allow parts with flat surfaces to be picked up. Another type of the picker tips can be developed to allow parts with convex features to be picked up securely. Another type of the picker tips can be developed to allow parts with protruded features to be located by the picker tip.

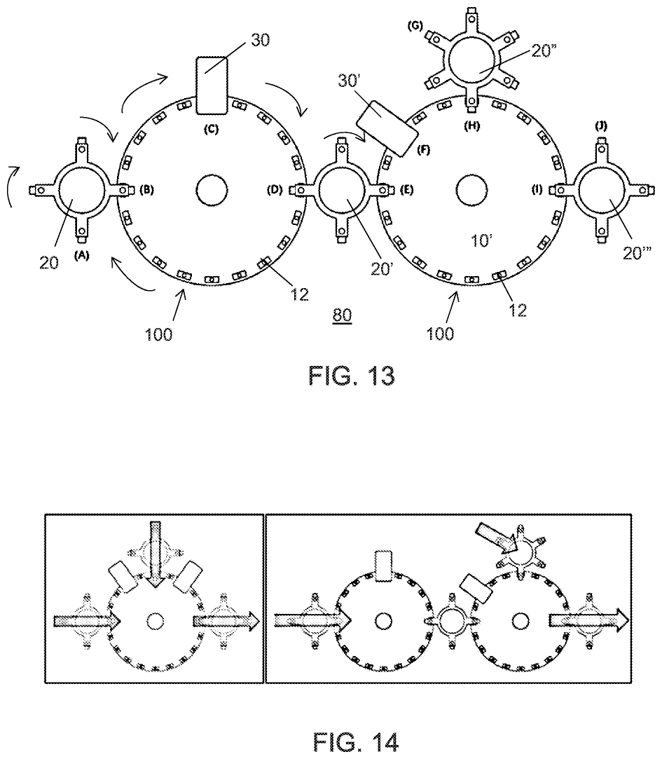

In the preferred embodiment of the present invention, the end effectors (22, 33) that can be customized easily with minimal changes allows the HSMC (80) to be flexible in handling parts of varying geometrical shape, material and/or size. There may be a plurality of end effectors (22) used to facilitate high speed part transfer, and the end effectors (22) are mounted on the end effector rotary table. Depending on how the manufacturing line is being laid out, the combination of four end effectors secondary rotary turrets (20) and/or 6 end effectors secondary rotary turrets (20) can be used (as shown in FIGS. 12A and 12B). FIG. 12A is a schematic illustration showing 4UP secondary rotary turret (20) that is associated with the high speed manufacturing cell (80) in accordance with the present invention, and FIG. 12B is a schematic illustration showing 6UP secondary rotary turret (20) that is associated with the high speed manufacturing cell (80) in accordance with the present invention. FIG. 13 is a schematic illustration depicting an iteration of the high speed manufacturing cell (80) that is created with the rearrangement of the primary rotary tables (100, 100′), a plurality of secondary rotary turrets (20, 20′, 20″), and/or stations (30, 30′) in accordance with the present invention. The HSMC (80) can thus be flexibly designed accordingly to available floor space on site.

The use of the direct drive rotary motors (24) for the secondary rotary turrets allows the iterations of the end effectors (22, 22′) to be positioned precisely and rapidly as well. The duplicate end effectors (22, 22′) are installed onto the secondary rotary turrets (20), and the rotary motor (24) indexes each end effector (22) at an angle alpha, where alpha=360 degrees/X (where X is the number of the end effectors installed). For N>=4, the indexing of each end effector (22) can be completed within a short time frame, enabling high speed transfer from one point to another, and hence high through put. The secondary rotary turret (20) mainly serves as a means of transportation for parts.

As shown in FIG. 10, the programmable linear actuators (28) that move along the Z axis are used to actuate the end effectors (22, 22′); this allows the end effectors (22, 22′) to interact with the part that is on the nest (12). A user of the HSMC (80) would be able to set teach points to the programmable linear actuators (28). This would eliminate the need for mechanical alignment along the Z axis to ensure handshaking of the end effectors (22, 22′) and the part on the nest (12) of the primary rotary table (100).

A turret mounting plate (26) is used to provide a datum surface which the rotary motor (24), the end effectors (22, 22′), and the programmable linear actuators (28) is referenced against. When aligning the secondary rotary turret (20) to the primary rotary table (100) (as shown in FIG. 4), only the turret mounting plate (26) needs to be moved; all other elements of the secondary rotary turret (20) is mounted onto the turret mounting plate (26). This would reduce the time taken to set up the individual HSMC (80).

The ability to create a unique secondary rotary turrets (20, 20′) that handles distinct parts with minimal changes to the basic elements of a secondary rotary turret (20,20′), helps the HSMC (80) be flexible and adaptable to engineering changes. For example, it should there be a change in design of geometric shape of part to be handled, only the end effector tips would need to be changed. The linear programmable actuator (28), the direct drive rotary motor (24), the turret mounting plate (26) can be kept the same. Thus, the cost of engineering changes would be reduced drastically, increasing rate of investment returns.

In accordance with the preferred embodiment of the present invention, other than the typical layout of the HSMC (80) referenced in FIG. 4, a plurality of HSMCs (80) can be configured into different iterations by rearranging the positioning and quantities of the following: the primary rotary tables (100), the secondary rotary turrets (20), and/or at least one stations (30).

In the layout of the primary rotary table (100) and the secondary rotary turret (20) to create a HSMC (80) unit, after each rotational index, a process would be performed on a part, where the part would be picked or placed by the secondary rotary turret (20), and a manufacturing process would be performed by the primary rotary table (100).

FIG. 4 is schematic top view showing the flow of parts in a HSMC (80) in accordance with the present invention, wherein the system includes three secondary rotary turrets (20, 20′, 20 —) and the primary rotary table (100) together with two stations (30, 30′) in accordance with the present invention.

The high-speed manufacturing cell (HSMC) (80) has relations to the field of automated manufacturing. Each of the HSMC (80) has the ability to perform a myriad of manufacturing processes on input parts, as well as facilitate parts transfer from one point to another within the HSMC (80).

The primary rotary table (100) contains a plurality of nests (12) that hold on to the parts. The nests (12) are indexed about its rotary table at a fixed angle by the primary rotary table (100), transporting the parts around the circumference of the rotary plate (10).

Stations are located at points along the circumference of the primary rotary tables (100), each performing manufacturing processes (i.e. laser welding, visual inspection of critical dimensions, insertion) on the parts as the nests are indexed through each station.

The secondary rotary turrets (20) perform pick and place operations and transferring of the parts to and from the primary rotary table (100). The parts are each placed onto each of the nests (12) of the primary rotary plate (10), and picked from the nests (12) of the primary rotary plate (10) after the manufacturing processes are performed by the stations (30, 30′). The secondary rotary turrets (20) comprises a plurality of end effectors (22) that interact with the part to facilitate transference. The end effectors (22) interact with the part mechanically, by means of the mechanical jaws (23) and/or the suction means, indicating by the arrow (34). Depending on the geometry of the part to be handled, any suitable end effectors (22) can be selected.

In accordance with the preferred embodiment of the present invention, an example of the flow of a part through a flexible HSMC (80) of the present invention is as follows (as shown in FIG. 4):
(a) A part is picked up by an end effector (22) mounted on a first secondary rotary turret (20) at point A;
(b) The first secondary rotary turret (20) rotates in a clockwise manner until the end effector (22) reaches point B;
(c) While steps (a) & (b) are happening, a second secondary rotary turret (20′) picks up another part at point D; the part is rotated clockwise until the part reaches point E;
(d) The part from step (c) is then placed by the end effector of the second secondary rotary turret onto a nest (12) mounted on the primary rotary table (100);
(e) Then, the primary rotary table (100) indexes the nest (12) with the part at a fixed angle;
(f) Once the nest (12) with the part reaches the station (30) at point C, a manufacturing process is activated to perform on the part;
(g) After the manufacturing process on the part from step (f) is completed, the primary rotary table (100) indexes the nest (12) with the part by the same fixed angle until it reaches point E. The second secondary rotary turret (20′) inserts the part into the part already located on the nest (12), forming into an assembly;
(h) After which, the primary rotary table (100) indexes the nest (12) by the same fixed angle until it reaches point F, where another manufacturing process is activate to perform on the assembly;
(i) The nest (12) transports the assembly with 2 manufacturing processes completed to point G;
(j) The end effector (22) of a third secondary rotary turret (20″) picks the part from the nest (12) at point G, and rotates in a clockwise manner until it reaches point H; and
(k) The part is released from the end effector (22″) of the third secondary rotary turret (20″), and is transported elsewhere.

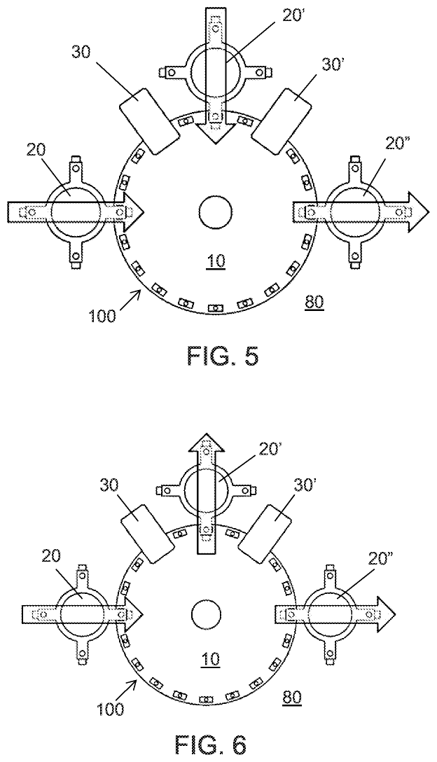

FIG. 5 is a top view showing schematically the converging of 2 inputs to 1 output of parts in a HSMC in accordance with the present invention; and FIG. 6 is a top view showing schematically the diverging 1 input to 2 outputs of parts in a HSMC (80) in accordance with the present invention.

The single HSMC (80) allows different parts from varying sources to be converged and output as a single unit. Another iteration of the HSMC (80) allows parts from a single source to be diverged to separate outputs, as shown in FIGS. 5 and 6. The use of direct drive rotary motor (14) that allows the direction of rotation to be swapped between clockwise and anticlockwise facilitates the convergence and divergence of parts in a HSMC (80).

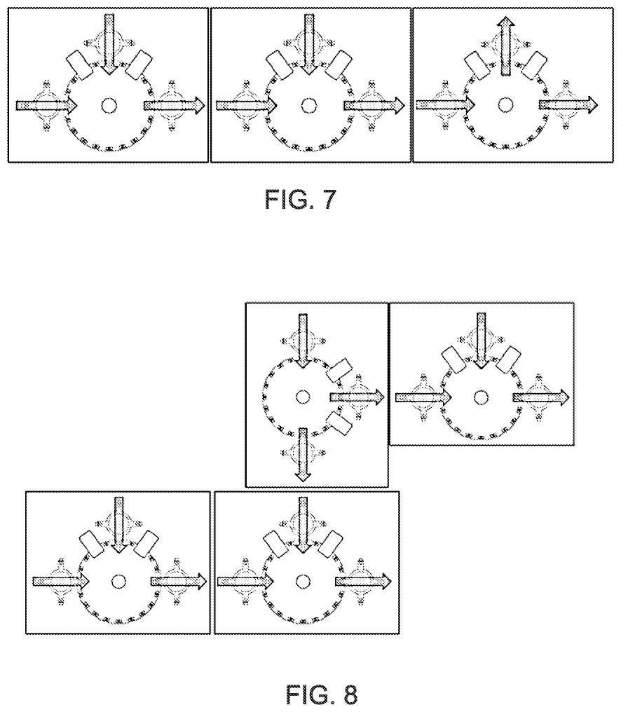

FIG. 7 is a top view showing iteration 1 of manufacturing line in accordance with the present invention, wherein three HSMCs are employed, and FIG. 8 is a top view showing iteration 2 of manufacturing line in accordance with the present invention, wherein four HSMCs are employed. The ability to customize input and output pathways via a mixture of convergence and/or divergence of parts allows individual HSMC (80) to be configured together to form differently shaped manufacturing lines based on the available floor space (as shown in FIG. 7 and FIG. 8). This facilitates high throughput manufacturing in a compact space.

FIG. 13 is a schematic illustration depicting an iteration of the high speed manufacturing cell (80) that is created with the rearrangement of the primary rotary tables (100), the secondary rotary turrets (20), and/or the stations (30) in accordance with the present invention. FIG. 13 is one other iteration of the HSMC (80) includes a plurality of primary rotary tables (100), and a mix of secondary rotary turrets with different quantities of end effectors (as shown in FIG. 13) and the stations (30, 30′) that perform manufacturing processes such as processing, assembly and/or sub assembly of parts, part assemblies, pressing, insertion, welding, electrical measurement, reorientation, visual inspection of critical dimensions can be fitted around a fixed circular pitch of the primary rotary tables (100, 100′). The flow of parts through this iteration of HSMC (80) would be as follows (as shown in FIG. 13):
(a) A part is input into the HSMC (80) at point A;
(b) A first secondary rotary turret (20) picks the part at point A with the end effector (22) of the first secondary rotary turret (20), rotating in a clockwise manner until it reaches point B on the primary rotary table (100);
(c) The linear programmable actuator (28) of the first secondary rotary turret (20) facilitates placement of the part onto the nest (12) of the primary rotary table (100);
(d) The primary rotary table (100) rotates the nest (12) with the part by a fixed pitched angle until it reaches point C on the primary rotary table (100);
(e) The station (30) located at the point C along the circumference of the primary rotary table (100) performs the desired manufacturing process on the part;
(f) After completion, the primary rotary table (100) rotates in a clockwise manner until the part reaches point D;
(g) A secondary rotary turret (20′) picks the part up at Point D with the end effector (22′), rotating in a clockwise manner until it reached the Point E;
(h) The linear programmable actuator (28) of the second secondary rotary turret (20′) facilitates placement of the part onto the nest (12) of a second primary rotary table (100′);
(i) The primary rotary table (100′) rotates the nest (12) with the part by a fixed pitched angle until it reaches the Point F;
(j) The station (30′) located at point F along the circumference of the second primary rotary table (100′) performs the desired manufacturing process on the part;
(k) After completion, the second primary rotary table (100′) rotates in a clockwise manner until the part reaches point H;
(l) Another part is input into the HSMC (80) at point G;
(m) A third secondary rotary turret (20″) picks the part up at point G with the end effector (22″), rotating in a clockwise manner until it reaches point H on the second primary rotary table (100′);
(n) The linear programmable actuator (28) of the third secondary rotary turret (20″) facilitates placement of the part into the part already present in the nest (12) at Point H, forming an assembly;
(o) The second primary rotary table (100′) rotate the assembly in a clockwise manner until it reaches Point I;
(p) The fourth secondary rotary turret (20 —) picks the part up at Point I with the end effector, rotating in a clockwise manner until it reaches point J; and
(q) The completed assembly then leaves the HSMC (80).

FIG. 16 is a schematic illustration depicting another iteration of the high speed manufacturing cell (HSMC) that allows for the inclusion of redundancies in automation in accordance with the present invention. This iteration of the HSMC (80) comprises a primary rotary table (100), a secondary rotary turret (20), two stations (30, 30′) for performing same manufacturing process. The flow of the part through this iteration of HSMC (80) is as follows:
(a) A part is input into the HSMC (80) via a first station (30) at point A;
(b) The primary rotary table (100) rotates in a clockwise manner to point B;
(c) The secondary rotary turret (20) picks up the part at point B via the end effector mounted thereon;
(d) The secondary rotary turret (20) rotates in a clockwise manner to point C, and the part is transferred out of the HSMC (80);
(e) When material supply is finished at point A of the primary rotary table (100), the station (30) at point A will stop functioning;
(f) The second station (30′) at point D will start functioning; part is input to the primary rotary table (100) at point D;
(g) The primary rotary table (100) rotates in an anticlockwise manner to point B;
(h) The secondary rotary turret (20) picks up the part at point B via the end effector mounted thereon and delivers the part to point C; and
(i) While the primary rotary table (100) collects the part from point D, material is replenished at the first station (20′) at point A.

In the preferred embodiment, the ability to introduce duplicate stations (30, 30′) performing identical manufacturing processes in the same compact work space eliminates down time, and the duplicate stations (30, 30′) are independent of each other. At instances where any one of the two stations (30, 30′) due to material changeover and/or maintenance, the other station would be able to perform the desired manufacturing process with relative ease, ensuring continued high throughput of the HSMC (80). This flexible HSMC of the present invention allows customers to have additional redundant stations in the same compact manufacturing space, as opposed to commissioning a secondary line for redundancy purposes.

In another preferred embodiment, there is shown another iteration of manufacturing line. FIG. 14 is a schematic illustration showing another iteration of manufacturing line, made by combining 2 different HSMCs in accordance with the present invention. The iteration is the combination of iteration of HSMC (80) shown in FIG. 4 with that of HSMC (80) shown in FIG. 13. A flexible manufacturing line able to develop in tandem with engineering changes is thus obtained with the following features:
(a) The creation of unique HSMCs capable of handling different part and manufacturing processes with minimal changes to the HSMC basic elements;
(b) Flexible pathways of parts in the HSMC (80) through a series of convergence and divergence via direct drive rotary action, which means that the input and output of parts is easily customized; and
(c) Variable footprint of manufacturing line depending on how the HSMCs are connected to each other.

In accordance with the present invention, Smart Alignment Methodologies (SAM) in a single High Speed Manufacturing Cell (HSMC) are employed which involve the use of programmable linear actuators present in the secondary rotary turret (20), as shown in FIG. 10, to facilitate pick and place operations of parts.

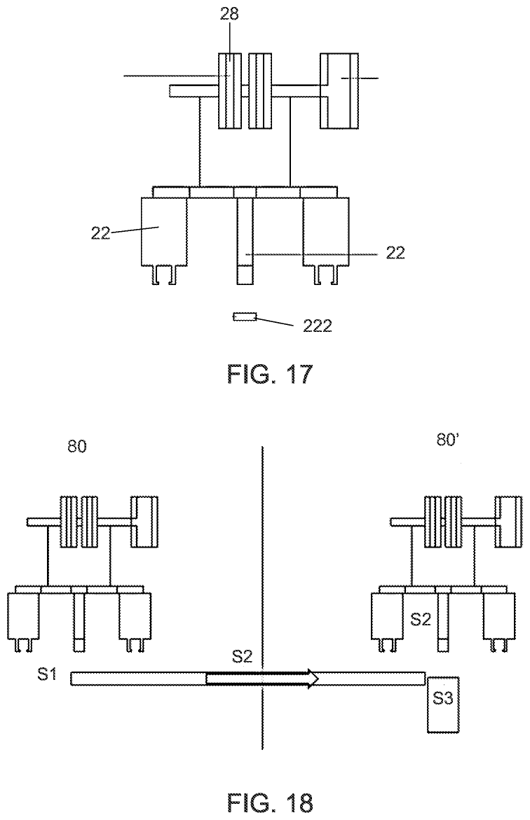

FIG. 17 is a schematic illustration showing the picking up of a part via smart alignment of HSMC (80) in accordance with the present invention. Referring to FIG. 17, the part to be picked by an end effector (22) of a secondary rotary turret (30) (not shown) for the part transfer would be located at a certain Z height. A teach point is set to the programmable linear actuator (28) located directly above the end effector (22). The teach point is a numerical value which the user enters into a software for HSMC (80). This value dictates the travel stroke of the programmable linear actuator (28). In accordance with the present invention, by having a teach point option embedded in the HSMC software, the users no longer need to physically shift the assembly location of the programmable linear actuator (28) in the event of misalignment, only needing to calibrate the assembly by key in the relevant numerical value.

During part picking operation, the programmable linear actuator (28) would move along the Z axis until it reaches its desired teach point position. The end effector (22) is pushed by the programmable linear actuator (28) till the desired teach point position. When in position, the end effector (22) interfaces with the part and picks up the part. The programmable linear actuator (28) then moves away from the teach point position, bringing the end effector (22) with the picked part along with the end effector (22). The secondary rotary turret (20) then rotates the end effector (22) with the part to the placement location. The programmable linear actuator (28) at the placement position would have its own unique teach point, different from that at the picking position. The programmable linear actuator (28) at the placement position moves to the placement teach point, pushing the end effector (22) carrying the part. The part is released from the end effector (22). The pick and place operation is completed via the use of the programmable linear actuator (28).

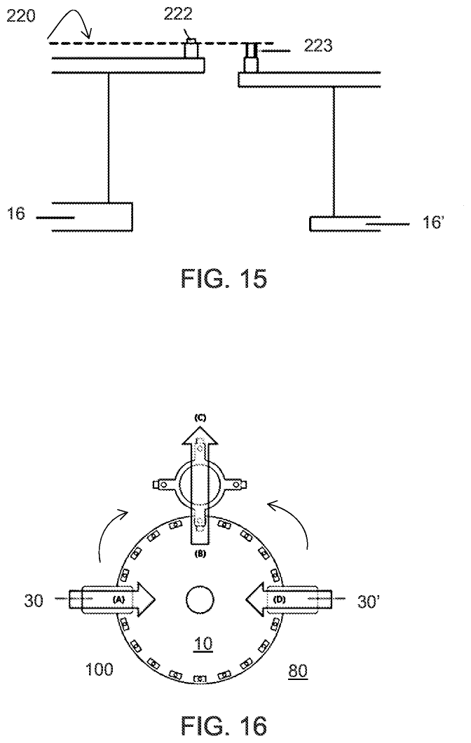

FIG. 15 is a schematic illustration showcasing a primary rotary table (100) of different height to facilitate handling of parts of different geometric dimensions, as well as stacking of 2 different parts (222, 223, as shown in FIG. 15) together to form a sub-assembly in accordance with the present invention. Referring to FIG. 15, the smart alignment methodologies (SAM) allows parts to be assembled in the vertical direction to form sub-assemblies of parts.

The mounting spacers (16, 16′) of the primary rotary tables (100, 100′) can be of different thickness, allowing the height of the primary rotary tables (100, 100′) to be varied. As shown, the mounting spacer (16) of one primary rotary table (100) is thicker than the mounting spacer (16′) of another primary rotary table (100′). In the building of a sub-assembly where part (222) is stacked onto part (223), the primary rotary table (100) handling the part (22) would be taller than the second primary rotary table (16′) handling the part (223) as a result of having a thicker mounting spacer for primary rotary table (16). The plane where the part (222) sits on the part (223) to form a sub-assembly is maintained, allowing the secondary rotary turret (20) to perform pick and place operations from the primary rotary table (100) to the second primary rotary table (100′). The dotted line (220) shown in FIG. 15 illustrates the plane which the part (222) is stacked onto the part (223).

In a HSMC (80) where multiple pick and place operations are performed at different points simultaneously, the ability to set unique teach points to the end effectors' respective programmable linear actuators (28) would eliminate the need for precise mechanical alignment along the Z axis. Variations in Z in assemblies due to stack up tolerances would thus be a non-factor, reducing the overall time needed to set up a HSMC (80) unit.

When a plurality of HSMC (80) units are configured together to form a manufacturing line, there is a need for smart alignment methodology to reduce the overall time taken to de-commission the manufacturing line and set up the HSMC (80) again in a new location.

FIG. 18 is a schematic illustration showing alignment between adjacent HSMC (80, 80′) units in a manufacturing line in accordance with the present invention. To facilitate alignment between HSMC (80, 80′) units, for instance a first HSMC (80) and a second HSMC (80′), in a manufacturing line, a linear track system is used. The linear track system of the present invention comprises a fixed stand to allow parts to be placed onto and/or picked from the linear track system, and a linear track assembly containing machined parts with orifices to allow a fluid medium to pass through, providing lift and propulsion to the part when interacting with the part.

Referring to FIG. 18, there is shown an example of how the linear track system being used to bridge two HSMC (80, 80′) units in a manufacturing line, and the steps are explained as follows:
(a) The part is placed at the end of the linear track system at the output of the first HSMC (80), denoted as point (S1);
(b) The part flows through the length of the linear track system until the part reaches the fixed stand located at the front of the linear track system, denoted as point (S3);
(c) The fixed stand, at point (S3), is aligned to the input of the second HSMC (80′); and
(d) The secondary rotary turret (20) of the second HSMC (80′), denoted as point (S4) picks the part up from the fixed stand of the linear track system at point (S3) and transfers the part down the manufacturing line.

In accordance with the preferred embodiment of the present invention, via the smart alignment methodology (SAM), the misalignments of adjacent HSMC (80) units in a manufacturing line along the X and Y axis would be negated, and the time to set up the manufacturing line is reduced, since there is no need for precise mechanical alignment between adjacent HSMC (80) units.

The linear track system functions as a low-cost method of transporting parts over large distances, the linear track system doubles up as a buffer unit. If the second HSMC (80′) becomes unavailable due to a jam, the first HSMC (80) would continue to produce parts to fill up the linear track system. Once the issue at the second HSMC (80′) is rectified, the parts stored in the linear track system would be consumed. If the first HSMC (80) becomes unavailable due to the jam, the second HSMC (80′) would be able to function due to the presence of parts stored in the linear track system. This alleviates the effect downtime of individual HSMC (80, 80′) units have on the entire manufacturing line's overall equipment effectiveness (OEE).

While the best mode for carrying out the invention has been described in detail, those familiar with the art to which this invention relates will recognize various alternative designs and embodiments for practicing the invention as defined by the following claims.

What is claimed is:

1. A high-speed manufacturing cell (HSMC) system for performing a myriad of manufacturing processes on an input part or more parts, the system comprising:
one or more primary rotary tables (100, 100′) which is circular having a rotary plate (10) and is rotated by a direct drive rotary motor (14) located underneath the rotary plate (10), wherein the rotary motor (14) together with the rotary plate (10) are positioned on a mounting spacer (16), and the circumferential edge of the primary rotary plate (10) is mounted with a plurality of nests (12) for holding the part; and
a plurality of secondary rotary turrets (20, 20′) adjacently positioned along the circumferential edge of the primary rotary plate (10), wherein the secondary rotary turret (20) comprises a direct drive rotary motor (24); a plurality of end effectors (22) each being provided with a pair of mechanical jaws (23) to pick and place the part onto the nest (12) on the primary rotary plate (10);
thereby the part is transferred from one place to another place to be processed and/or to form a sub-assembly in the course of pick and place by the end effector (22) of the secondary rotary turret (20).

2. A high-speed manufacturing cell (HSMC) system for performing a myriad of manufacturing processes on an input part or more parts, the system comprising:
one or more primary rotary tables (100, 100′) which is circular having a rotary plate (10) and is rotated by a direct drive rotary motor (14) located underneath the rotary plate (10, 10′), wherein the rotary motor (14) together with the rotary plate (10) are positioned on a mounting spacer (16), and the circumferential edge of the primary rotary plate (10) are mounted with a plurality of nests (12) for holding the part; and
a plurality of secondary rotary turrets (20, 20′) adjacently positioned along the circumferential edge of the primary rotary plate (10), wherein the secondary rotary turret (20) comprises a direct drive rotary motor (24); a plurality of end effectors (22) each being provided with a pair of mechanical jaws (23) to pick and place the part onto the nest (12) on the primary rotary table (100); and
at least one station (30) positioned above the circumferential edge of the primary rotary plate (10) to provide a manufacturing process to the part on the nest (12), thereby the part is transferred from one place to another place to be processed and/or to form a sub-assembly in the course of pick and place by the end effectors (22) of the secondary rotary turret (20).

3. The high-speed manufacturing cell (HSMC) system as set forth in claim 2, wherein the mechanical jaws (23) are positioned at one end of the end effectors (22) for pick and place of part for manufacturing lines.

4. The high-speed manufacturing cell (HSMC) system as set forth in claim 2, wherein the nest (12) is selected from the group consisting of a locating nest (121), a translating nest (122), a rotating nest (123) and a clamping nest (124).

5. The high-speed manufacturing cell (HSMC) system as set forth in claim 2, wherein the end effector (22) is formed into a vacuum mean to provide suction for pick and place of the part in the manufacturing line.

6. The high-speed manufacturing cell system as set forth in claim 2, wherein the secondary rotary turret (20) is provided with a turret mounting plate (26) located on top of the direct drive rotary motor (24).

7. The high-speed manufacturing cell (HSMC) system as set forth in claim 6, wherein one or more programmable linear actuators (28) are coupled at the edge of the turret mounting plate (26) and the linear actuators (28) move simultaneously with that of the turret mounting plate (26).

8. The high-speed manufacturing (HSMC) cell system as set forth in claim 2, wherein the primary rotary tables (100, 100′), the secondary rotary turrets (20, 20′, 20″) and one or more stations (30, 30′, 30″) are being configured to provide a system to handle myriad manufacturing processes.

9. The high-speed manufacturing cell system (HSMC) as set forth in claim 1, wherein the primary rotary tables (100, 100′), and the secondary rotary turrets (20, 20′) are being configured to provide a system to handle myriad manufacturing processes.

10. The high-speed manufacturing cell (HSMC) system as set forth in claim 1 or claim 2, wherein the end effectors (22) are able to pick and place the part or handle the part of varying geometrical dimensions, weight, and material.

11. The high-speed manufacturing cell (HSMC) system as set forth in claim 10, wherein the mechanical jaws (23) are used to pick and place the parts of varying geometrical dimensions, weight and material.

12. The high-speed manufacturing cell (HSMC) system as set forth in claim 5, wherein the vacuum means are used to pick and place the part of varying geometrical dimensions, weight and material.

13. The high-speed manufacturing cell (HSMC) system as set forth in claim 2, wherein a plurality of primary rotary tables (100, 100′, 100″) and a plurality of secondary rotary turrets (20, 20′, 20′″) together with one or more stations (30, 30′) are being used to configured to form non-linear manufacturing lines which are customized based on available floor space.

14. A high-speed manufacturing cell (HSMC) system employing a smart alignment methodology for performing a myriad of manufacturing processes on input part/parts comprising one or more HSMCs (80) with a mounting spacer (16), a secondary rotary turret (20) with an end effector (22) equipped with a programmable linear actuator (28) to allow the parts to be assembled in vertical direction to form sub-assemblies of parts, wherein a teach point is set to the programmable linear actuator (28) based on the height of the part to be picked.

15. The high-speed manufacturing cell (HSMC) system employing a smart alignment methodology as set forth in claim 14, wherein the programmable linear actuator (28) moves along the Z-axis until the end effector (22) of the secondary rotary turret (20) reaches the desired teach point position to pick up the part.

16. The high-speed manufacturing cell (HSMC) system employing a smart alignment methodology as set forth in claim 14, wherein the mounting spacer (16) of the primary rotary table (100) of different thickness varies the height of the primary rotary table (100).

17. The high-speed manufacturing cell (HSMC) system employing a smart alignment methodology (SAM) as set forth in claim 14, wherein a set of teach points are set to the end effectors (22) of the respective programmable linear actuator (28) such that the HSMC (80) can perform multiple pick and place operations.

18. The high-speed manufacturing cell (HSMC) system employing a smart alignment methodology as set forth in claim 14, further comprising a linear track system to facilitate a plurality of HSMCs (80, 80′) to be in alignment in a manufacturing line.

19. The high-speed manufacturing cell (HSMC) system employing a smart alignment methodology as set forth in claim 18, wherein the linear track system comprises a fixed stand to allow the part to be placed onto and or picked from the linear track system; and a linear track assembly containing machined parts with orifices to allow a fluid medium to pass through, providing a lift and propulsion the part when the assembly interacts with the part.

20. The high-speed manufacturing cell (HSMC) system employing a smart alignment methodology as set forth in claim 18, wherein the linear track system is used to bridge two or more HSMC (80, 80′) units in the manufacturing line.

21. The high-speed manufacturing cell (HSMC) system for performing a myriad of manufacturing processes on input part/parts as set forth in claim 2, wherein one or more stations (30, 30′) are used in processing parts to form subassemblies.

22. The high-speed manufacturing cell (HSMC) system employing a smart alignment methodology as set forth in claim 17, wherein the teach point is programmable in the linear actuators (26) of the secondary rotary turret (20).
